(19) United States
(12) Patent Application Publication
(10) Pub. No.: US 2026/0338388 A1
(43) Pub. Date: Oct. 29, 2026

(54) DISTRICT HEATING PLANT AND METHOD

(71) Applicant: SNF GROUP, ANDREZIEUX-BOUTHEON (FR)

(72) Inventor: Danilo BOMBARDI, VAREDO (IT)

(21) Appl. No.: 19/485,776

(22) PCT Filed: May 22, 2024
(86) PCT No.: PCT/EP2024/064087

§ 371 Date: Nov. 19, 2025

(30) Foreign Application Priority Data
May 23, 2023 (IT) 102023000010410
Sep. 7, 2023 (IT) 102023000018399

(51) Int. Cl. F24D 10/00; F25B 7/00

(52) U.S. Cl. CPC F24D 10/003; F25B 7/00; F25B 2339/047

(57) ABSTRACT

“A district heating plant (100) includes a heating system (110) for heating a main fluid, the heating system having at least one heat pump module (1) that includes:
a first circuit (2) for a first refrigerant fluid and a second circuit (3) for a second refrigerant fluid;
a first heat exchanger (4) arranged on the first circuit (2) for a heat exchange between the first refrigerant fluid and a first heat transfer fluid; and a first compressor (5) arranged on the first circuit (2) downstream of the first heat exchanger (4). A
second heat exchanger (6) is interposed between the first circuit (2) and the second circuit (3) for a heat exchange between the first refrigerant fluid and the second refrigerant fluid, the said second heat exchanger (6) being located on the first circuit (2) downstream of the first compressor (5).
A first expansion valve (7) is arranged on the first circuit (2) downstream of the second heat exchanger (6); and
a second compressor (8) is arranged on the second circuit (3) downstream of the second heat exchanger (6); with
a third heat exchanger (9) being arranged on the second circuit (3) downstream of the second compressor (8) for a heat exchange between the second refrigerant fluid and a second heat transfer fluid.

A heat exchange apparatus (101) is operatively associated with at least the second heat transfer fluid; and a distribution network (120) is provided for distributing the main fluid to a plurality of users.

The present invention relates to a district heating plant and method.

As is well known, district heating is a network-based system in which the heat produced from a generation source is distributed to users by means of a transfer fluid (mostly water, or steam). The latter distributes heat to users via “delivery” pipes and returns, by now cooled, through “return” pipes.

The heat generator used in district heating can be of various types, from fossil fuel generators to biomass boilers, solar thermal collectors, heat pumps and cogeneration systems.

As is well known, a heat pump is a device that extracts heat from one or more low-temperature sources in order to supply it to one or more high-temperature sources, with the aid of an external source of energy.

Heat pumps are designed to move heat energy in a direction opposite that of the spontaneous heat flow, by absorbing heat from a cold space and releasing it into a warmer one.

At the basis of the operation of a heat pump is the use of a volatile fluid that evaporates and condenses, known as a refrigerant fluid.

The compressor of a heat pump draws the refrigerant fluid in the form of a gas, compressing it in the high-pressure zone of the circuit. The compressed gas is pushed into a first heat exchanger (condenser), where it transfers heat to the environment and cools until condensing into liquid form. The liquid is pushed through an expansion valve that separates the high-pressure part from the low-pressure part of the circuit. When the liquid, now at a low pressure, reaches a second heat exchanger (evaporator), it absorbs heat from the environment and passes into gaseous form so as to be again drawn in by the compressor, starting the cycle over again.

Typically, a heat pump uses a refrigerating cycle to remove heat from a low-temperature source and return it to a higher thermal level in order to enable an effective use of its heat content at temperatures suitable for a thermal utility.

However, the outlet temperatures that are reached by a standard heat pump lie between 70 °C and 80 °C. For these reasons, the known heat pumps are not particularly suitable for use in district heating, as it is necessary for the heat transfer fluid to reach for example 130 °C-180 °C.

In this context, the technical task at the basis of the present invention is to propose a district heating plant and method which overcomes the abovementioned drawbacks of the prior art.

In particular, it is an object of the present invention to propose a district heating plant and method that is highly efficient, but at the same time capable of introducing a heat transfer fluid at temperatures comprised between 130 °C and 185 °C, and up to 250 °C, into the distribution network for the distribution thereof to users.

Another object of the present invention is to provide a district heating plant and method, wherein the heat generator is capable of producing both a hot heat transfer fluid and a cold heat transfer fluid with the same energy consumption as the known solutions that produce only a hot heat transfer fluid.

The stated technical task and specified objects are substantially achieved by a district heating plant and method comprising the technical features disclosed in one or more of the appended claims.

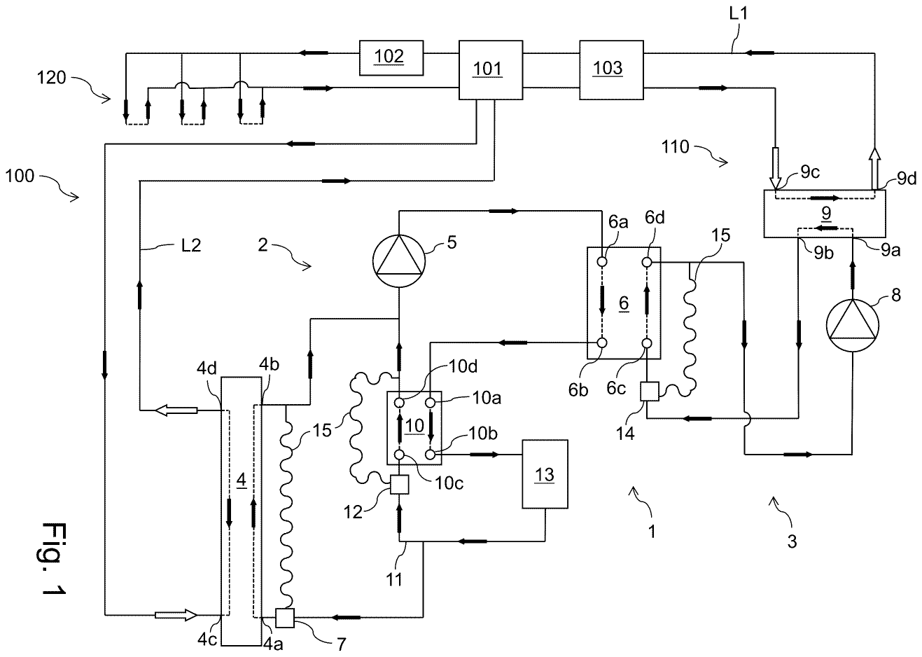

Additional features and advantages of the present invention will emerge more clearly from the approximate, and thus non-limiting, description of a preferred but not exclusive embodiment of a district heating plant and method as illustrated in the appended FIG. 1, which illustrates a schematic view of a district heating plant according to the present invention.

With reference to FIG. 1, the number 100 indicates a district heating plant according to the present invention. In particular, the district heating plant is urban.

The district heating plant 100 comprises a heating system 110 for heating a main fluid and a distribution network 120 for distributing the main fluid to a plurality of users. The main fluid is in fact a carrier of heat to users.

The heating system 110 comprises at least one heat pump module 1.

The heat pump module 1 comprises a first circuit 2 for a first refrigerant fluid and a second circuit 3 for a second refrigerant fluid.

The heat pump module 1 comprises a first heat exchanger 4 arranged along the first circuit 2. Preferably, the first heat exchanger 4 comprises an inlet 4a and an outlet 4b for the first refrigerant fluid. Preferably, the first heat exchanger 4 comprises an inlet 4c and an outlet 4d for a first heat transfer fluid.

The first heat exchanger 4 is an evaporator. The heat exchange between the first refrigerant fluid and the first heat transfer fluid is such that the first refrigerant fluid passes into the gaseous state.

The first heat transfer fluid is often identified as the “cold source” since a refrigerant fluid with a low boiling point is used, and it is thus possible to use a low-temperature fluid. The cold source is usually water, to which glycol may be added, or another fluid. Typically, the inlet temperature lies between 10 °C and 25 °C and the outlet temperature between 5 °C and 10 °C.

In one embodiment, the first heat transfer fluid, for example water, enters the first heat exchanger 4 at about 12 °C and exits at about 7 °C.

For these reasons, it is possible to refer to the first heat transfer fluid as a “cold heat transfer fluid”.

The heat pump module 1 comprises at least a first compressor 5 arranged downstream of the first heat exchanger 4. In one embodiment, the heat pump module 1 comprises at least two first compressors 5 in series.

The heat pump module 1 comprises a second heat exchanger 6. The second heat exchanger 6 is interposed between the two circuits 2, 3. In particular, the second heat exchanger 6 is shared between the first and the second circuit 2, 3. In other words, the second heat exchanger 6 acts on the first circuit 2 and on the second circuit 3.

The second heat exchanger 6 is arranged on the first circuit 2 downstream of the first compressor 5. The heat exchange between the first refrigerant fluid and the second refrigerant fluid takes place in the second heat exchanger 6, as will be better described below.

Preferably, the second heat exchanger 6 comprises an inlet 6a and an outlet 6b for the first refrigerant fluid. Preferably, the second heat exchanger 6 comprises an inlet 6c and an outlet 6d for the second refrigerant fluid.

The heat pump module 1 comprises a first expansion valve 7 arranged on the first circuit 2 between the outlet 6b of the second heat exchanger 6 and the inlet 4a of the first heat exchanger 4.

The heat pump module 1 comprises at least one second compressor 8 arranged on the second circuit 3 downstream of the second heat exchanger 6. In one embodiment, the heat pump module 1 comprises at least two second compressors 8 in series.

The heat pump module 1 comprises a third heat exchanger 9 arranged on the second circuit 3 downstream of the second compressor 8. Preferably, the third heat exchanger 9 comprises an inlet 9a and an outlet 9b for the second refrigerant fluid. Preferably, the third heat exchanger 9 comprises an inlet 9c and an outlet 9d for a second heat transfer fluid.

The second heat transfer fluid is a fluid intended to receive heat from the heat pump module 1 in order to transfer it, directly or indirectly, to the main fluid.

In contrast with the first heat transfer fluid, the second heat transfer fluid is identified as a “hot heat transfer fluid”.

Preferably, the third heat exchanger 9 is of the flooded type. In this manner, it also performs the function of a liquid receiving device.

The heat pump module 1 comprises a second expansion valve 14 arranged on the second circuit 3 between the outlet 9b of the third heat exchanger 9 and the inlet 6c of the second heat exchanger 6.

Preferably, the heat pump module 1 comprises the first refrigerant fluid flowing in the first circuit 2 and the second refrigerant fluid flowing in the second circuit 3.

Preferably, the heat pump module 1 is configured so that the second heat transfer fluid is brought into the third heat exchanger 9 at temperatures comprised between 80 °C and 125 °C.

By way of non-exhaustive example, the second heat transfer fluid can be open-or closed-vessel diathermic oil, inhibited calcium carbonate, or demineralised water with the addition of glycols. Preferably, the second heat transfer fluid is a diathermic oil.

The first refrigerant fluid in the first circuit 2 is thus used for the thermal conditioning of the second refrigerant fluid in the second circuit 3. The second heat transfer fluid directly receives heat only from the second refrigerant fluid. In particular, the heat pump module 1 is configured so that the first refrigerant fluid removes heat from the second refrigerant fluid in the second heat exchanger 6, causing the first refrigerant fluid to condense.

Preferably, the second heat exchanger 6 is configured as a condenser for the first refrigerant fluid.

Conveniently, the first refrigerant fluid and the second refrigerant fluid are different from each other. “Different” here means that the first refrigerant fluid is a substance differing from the second refrigerant fluid. In other words, their chemical nature is different.

Preferably, the first refrigerant fluid is R513A, R134 or R552A. It is likewise possible to use any refrigerant fluid of the HFC and HFO type with a GWP below 1000. Alternatively, the first refrigerant fluid is subcritical CO 2.

Preferably, the first refrigerant fluid is R513A, whose chemical composition is a mix of 1,1,1,2-Tetrafluoroethane and 2,3,3,3-Tetrafluoroprop-1-ene. This fluid offers the advantage of a condensation temperature around 70 °C.

Preferably, the second refrigerant fluid is R1233zd, R1234yf or R1234ze. It is likewise possible to use any refrigerant fluid of the HFO type with a GWP below 10. Alternatively, the second refrigerant fluid is butane, propane, or pentane. Preferably, the second refrigerant fluid is R1233zd, whose chemical composition is trans-1-Chloro-3,3,3-trifluoropropene.

Preferably, the first refrigerant fluid is R513A and the second refrigerant fluid is R1233zd. This combination is particularly advantageous in terms of heat pump efficiency and experimental trials have shown it to be the best possible combination in relation to the desired temperatures.

Below is a description of the cycle of the first refrigerant fluid. In the first heat exchanger 4 a heat exchange takes place such that the temperature of the first refrigerant fluid increases, whilst the temperature of the first heat transfer fluid decreases. In particular, the first refrigerant fluid evaporates, transforming into a gas. It then passes through the first compressor 5, in which the pressure of the first refrigerant fluid and consequently its temperature increase, exploiting the reduction in volume. The first refrigerant fluid is sent into the second heat exchanger 6, in which a heat exchange takes place between the first refrigerant fluid and the second refrigerant fluid. The first refrigerant fluid transfers heat to the second refrigerant fluid; in this manner the first refrigerant fluid cools and is condensed. The first refrigerant fluid then passes through the first expansion valve 7 to start its cycle over again.

Below is a description of the cycle of the second refrigerant fluid.

The second refrigerant fluid enters the second compressor 8, in which the pressure of the refrigerant fluid and consequently its temperature increase, exploiting the reduction in volume. It then passes through the third heat exchanger 9, in which a heat exchange takes place with the second heat transfer fluid. In particular, the second refrigerant fluid transfers heat to the second heat transfer fluid. After that, the second refrigerant fluid passes through the second expansion valve 14, and then enters the second heat exchanger 6, in which it receives heat from the first refrigerant fluid, causing the first refrigerant fluid to condense.

It is preferred that the temperature of the first refrigerant fluid entering the second heat exchanger 6 be higher than the temperature of the second refrigerant fluid entering the second heat exchanger 6. It is also preferred that the heat exchange be sufficient to cause the first refrigerant fluid to condense. It is not possible to identify precise temperatures of the refrigerant fluids entering the second heat exchanger 6, as this will vary based on many parameters which can differ from case to case.

By way of example, the second refrigerant fluid enters the second compressor 8 at 60 °C and 10 bar and exits at 125 °C and 40 bar. It then passes through the third heat exchanger 9, in which it transfers heat to the second heat transfer fluid. On leaving the third heat exchanger 9, the second refrigerant fluid is at 70 °C. Finally, it enters the second heat exchanger 6, where it is heated by the first refrigerant fluid at 80 °C and 10 bar. This causes the first refrigerant fluid to cool and condense.

By way of example, the first refrigerant fluid enters the second heat exchanger 6 at 70 °C, whereas it is throttled at 5 °C.

In accordance with one embodiment, the heat pump module 1 comprises an economizer 10 arranged to perform the task of lowering the temperature of the first refrigerant fluid leaving the second heat exchanger 6 before the first expansion valve 7.

Preferably, the economizer 10 comprises a first inlet 10a, located downstream of the first outlet 6b of the second heat exchanger 6, the first inlet 10a being connected to a first outlet 10b, arranged upstream of the first expansion valve 7. Preferably, the heat pump module 1 comprises a branch 11 of the first circuit 2 which may be configured to draw at least part of the first refrigerant fluid between the first outlet 10b of the economizer 10 and the first expansion valve 7. The branch 11 extends in such a way as to bring the first refrigerant fluid thus drawn towards the first compressor 5 passing through the economizer 10, more specifically through a second inlet 10c and a second outlet 10d of the economizer. A third expansion valve 12 is provided along the branch 11 upstream of the second inlet 10c of the economizer 10.

The first refrigerant fluid drawn in the branch 11 is used in the economizer 10 to cool the first refrigerant fluid, before it is sent to the first expansion valve 7. In other words, the economizer 10 operates through internal resources of the first circuit 2, as a mean for optimizing the performance of the first circuit 2.

Conveniently, the heat pump module 1 may comprise a liquid receiver device 13 arranged on the first circuit 2 between the second heat exchanger 6 and the first expansion valve 7. Preferably, the liquid receiver device 13 is located between the first outlet 10b of the economizer 10 and the start of the branch 11 The heat exchangers mentioned in the present invention can be of the tube bundle or plate type or another type.

In the preferred embodiment, the first heat exchanger 4 and the third heat exchanger 9 are of the tube bundle type, whereas the second heat exchanger 6 is of the plate type.

As represented on FIG. 1, the heat pump module 1 may comprise one, two or three capillary tube 15 associated with the expansion valves 7, 12, 14. The role of the capillary tube 15 is to send some refrigerant fluid directly to the compressor 5, 8, if the opening of the expansion valve 7, 12, 14 does not allow all the refrigerant fluid to pass through it.

The heat pump module 1 described above is capable of delivering up to 1 MW of thermal power. It is possible to connect a number of heat pump modules 1 together to increase the obtainable thermal power.

The heat pump of the present invention can thus be modulated.

Preferably, the plant 100 comprises a first refrigerant fluid flowing in the first circuit 2 of the heat pump module 1.

Preferably, the plant 100 comprises a second refrigerant fluid flowing in the second circuit 3 of the heat pump module 1.

Preferably, the plant 100 comprises a main fluid flowing in the distribution network 120.

The district heating plant 100 comprises a heat exchange apparatus 101 operatively associated with at least the second heat transfer fluid. This means that the heat transfer fluid contributes directly or indirectly (i.e. by means of an interposed fluid) to the heat exchange in the apparatus 101.

Preferably, in the apparatus 101 the main fluid receives heat coming directly or indirectly from the second heat transfer fluid.

Preferably, the plant 100 comprises a first line L1 for bringing the second heat transfer fluid from the heat pump module 1 to the apparatus 101.

Preferably, the plant 100 comprises a second line L2 for drawing the first heat transfer fluid leaving the first heat exchanger 4. Preferably, the second line extends in such a way as to bring the first heat transfer fluid into the apparatus 101 in order to thermoregulate the heat exchange.

In accordance with one embodiment, the apparatus 101 is configured to generate steam at a low pressure (in a range comprised between 2 and 6 bar, more preferably 4-5 bar). In other words, the apparatus 101 is a steam generator, i.e. the main fluid is steam.

In this case, the plant 100 preferably comprises one or more recompression units 102 downstream of the apparatus 101 in order to compress the steam again and increase its temperature. In particular, the recompression unit 102 is configured to bring the steam up to 22 bar, with consequent superheating up to about 250 °C.

Preferably, the recompression unit 102 comprises Roots-type blowers or Venturi turbochargers or semi-hermetic or open compressors with coupling and bell cover (to enable a better cooling of the motor block) or rotary screw compressors. In particular, the compressors can be of the screw, piston, or centrifugal type. Preferably, it is recommended to use screw compressors of the SR5 series by the manufacturer SRM TEC and SRM ITALY srl.

Conveniently, upstream of the compressor there is provided a liquid receiver to prevent damage by liquid “slugging” deriving from partially recondensed steam. In this manner, the outgoing steam is saturated and can easily reach the temperature and pressure parameters described above.

FIG. 1 only represents the first heat transfer fluid being sent to the apparatus 101 through the line L2, but other uses of first heat transfer fluid are possible. In particular, all of the first heat transfer fluid, or a part of it, upon exiting the first heat exchanger 4, may be sent to one or several units consuming cold energy, for example a refrigeration or cooling apparatus, not operatively associated with the apparatus 101.

Preferably, the plant 100 comprises a first buffer tank 103 for storing the second heat transfer fluid. The first tank 103 is preferably connected to a gas boiler or to a group of electric heating elements, should it be necessary to further increase the temperature of the hot heat transfer fluid.

Preferably, the plant comprises a second buffer tank (not illustrated) for storing the first heat transfer fluid.

Preferably, the plant 100 comprises a pumping unit to pump the main fluid into the distribution network 120.

A district heating method is an object of the present invention and is described below. The method is advantageously implemented by the heat pump module and plant as described above.

The method comprises a step of heating a main fluid.

The step of heating a main fluid comprises a step of circulating a first refrigerant fluid along a first circuit 2.

During the circulation in the first circuit 2, the step of heating a main fluid comprises a step of heat exchange between the first refrigerant fluid and a first heat transfer fluid. In this step, the first heat transfer fluid transfers heat to the first refrigerant fluid, which evaporates. Preferably, this step takes place in the first heat exchanger 4.

The first heat transfer fluid is often identified as the “cold source” since a refrigerant fluid with a low boiling point is used, and it is thus possible to use a low-temperature fluid. The cold source is usually water, to which glycol may be added, or another fluid. Typically, the inlet temperature lies between 10 °C and 25 °C and the outlet temperature between 5 °C and 10 °C.

In one embodiment, the water enters at about 12 °C and exits at about 7 °C.

For these reasons, it is possible to refer to the first heat transfer fluid as a “cold heat transfer fluid”.

The step of heating a main fluid comprises a step of circulating a second refrigerant fluid along a second circuit 3.

During the circulation in the second circuit 3, the step of heating a main fluid comprises a step of heat exchange between the second heat transfer fluid and a second refrigerant fluid. In this step, the second heat transfer fluid receives heat from the second refrigerant fluid. Preferably, this step takes place in the third heat exchanger 9.

The second heat transfer fluid is a fluid intended to receive heat from the second refrigerant fluid in order to carry it to a destination in which it transfers heat, directly or indirectly, to a substance.

In contrast with the first heat transfer fluid, the second heat transfer fluid is identified as a “hot heat transfer fluid”.

The step of heating a main fluid comprises a step of heat exchange between the first refrigerant fluid and the second refrigerant fluid. In this step, the second refrigerant fluid is heated by the first refrigerant fluid. This takes place after the second refrigerant fluid has transferred heat to the second heat transfer fluid. Preferably, this step takes place in the second heat exchanger 6.

The step of heating a main fluid comprises a step of heat exchange between the second heat transfer fluid and the main fluid. The second heat transfer fluid transfers heat to the main fluid. In particular, the second heat transfer fluid has already been heated by the second refrigerant fluid.

Preferably, the method comprises a step of compressing the first refrigerant fluid. This step takes place before the heat exchange between the first refrigerant fluid and the second refrigerant fluid. Preferably, this step takes place by means of the first compressor 5.

Preferably, the method comprises a step of expanding the first refrigerant fluid. This step takes place after the heat exchange between the first refrigerant fluid and the second refrigerant fluid. Preferably, this step takes place by means of the first expansion valve 7.

Preferably, the method comprises a step of compressing the second refrigerant fluid. This step takes place before the heat exchange between the second heat transfer fluid and the second refrigerant fluid.

By way of example, the second refrigerant fluid is compressed from 60 °C and 10 bar to 125 °C and 40 bar. It then transfers heat to the second heat transfer fluid, going down to 70 °C. Finally, it is heated by the first refrigerant fluid at 80 °C and 10 bar. The cooling is such as to cause the first refrigerant fluid to condense.

By way of example, the first refrigerant fluid is at 70 °C before the heat exchange with the second refrigerant fluid, whereas it is throttled at 5 °C.

Preferably, the method comprises a step of heat exchange between the first heat transfer fluid and the main fluid. The substance is cooled by the first heat transfer fluid.

Conveniently, the first refrigerant fluid and the second refrigerant fluid are different from each other. “Different” here means that the first refrigerant fluid is a substance differing from the second refrigerant fluid. In other words, their chemical nature is different.

Preferably, the first refrigerant fluid is R513A, R134 or R552A. It is likewise possible to use any refrigerant fluid of the HFC and HFO type with a GWP below 1000. Alternatively, the first refrigerant fluid is subcritical CO 2.

Preferably, the first refrigerant fluid is R513A.

Preferably, the second refrigerant fluid is R1233zd, R1234yf or R1234ze. It is likewise possible to use any refrigerant fluid of the HFO type with a GWP below 10. Alternatively, the second refrigerant fluid is butane, propane, or pentane. Preferably, the first refrigerant fluid is R513A and the second refrigerant fluid is R1233zd. This combination is particularly advantageous in terms of heat pump efficiency and experimental trials have shown it to be the best possible combination in relation to the desired temperatures.

The method comprises a step of circulating the main fluid within a distribution network 120 for the distribution thereof to a plurality of users.

Preferably, the method comprises a step of generating steam by means of a heat exchange with the second heat transfer fluid. In other words, the main fluid is steam as a result of the heat exchange with the second heat transfer fluid. Preferably, the method comprises a step of recompressing the main fluid along the distribution network 120.

In particular, the steam generated is within a range comprised between 2 and 6 bar, more preferably 4-5 bar.

The recompression results in an increase in the pressure of the main fluid up to 22 bar, with consequent superheating up to about 250 °C.

Preferably, the recompression takes place by means of Roots-type blowers or Venturi turbochargers or by means of semi-hermetic or open compressors with coupling and bell cover (to enable a better cooling of the motor block). In particular, the compressors can be of the screw, piston, or centrifugal type. Preferably, it is recommended to use screw compressors of the SR5 series by the manufacturer SRM TEC and SRM ITALY srl.

Conveniently, upstream of the compressor there is provided a liquid receiver to prevent damage by liquid “slugging” deriving from partially recondensed steam. In this manner, the outgoing steam is saturated and can easily reach the temperature and pressure parameters described above.

The present invention achieves important advantages.

First of all, the district heating plant with the proposed heat pump module is capable of producing a cold heat transfer fluid and a hot heat transfer fluid. Energy consumption being equal, a heat pump with a single refrigerant fluid circuit would not be able to produce cooling.

Moreover, the proposed heat pump module is capable of providing a hot heat transfer fluid up to 135 °C, which, in the case of steam generation, results in a steam that can reach up to 250 °C by means of the recompression units.

In addition, the proposed plant is able to function without external cold or hot sources. The cold source of the heat pump module 1 is the first heat transfer fluid. The calories drawn from the first heat transfer fluid may come from a unit consuming cold energy, for example a refrigerating or cooling means, or from the apparatus 101, where the first heat transfer fluid may be used to thermoregulate the transfer of heat from the second heat transfer fluid to the main fluid. The hot source of the heat pump module 1 is the second heat transfer fluid. The calories carried by the second heat transfer fluid may be injected in a distribution network 120.

From experimental trials it has emerged that the proposed heat pump module has an efficiency comprised between 4,5 and 14 (COP—“Coefficient of Performance”).

The use of a heat pump for a district heating plant results in numerous advantages, as there are no CO₂ emissions and more polluting heating systems can be replaced.

1. A district heating plant, comprising:
a heating system for heating a main fluid, said heating system comprising:
at least one heat pump module, comprising:
a first circuit for a first refrigerant fluid and a second circuit for a second refrigerant fluid;
a first heat exchanger arranged on the first circuit for a heat exchange between the first refrigerant fluid and a first heat transfer fluid;
a first compressor arranged on the first circuit downstream of the first heat exchanger;
a second heat exchanger interposed between the first circuit and the second circuit for transferring heat from the first refrigerant fluid to the second refrigerant fluid, causing said second refrigerant fluid to condense, said second heat exchanger being located on the first circuit downstream of the first compressor;
a first expansion valve arranged on the first circuit between the second heat exchanger and the first heat exchanger;
a second compressor arranged on the second circuit downstream of the second heat exchanger;
a third heat exchanger arranged on the second circuit downstream of the second compressor for heat exchange between the second refrigerant fluid and a second heat transfer fluid; and
a second expansion valve arranged on the second circuit between the third heat exchanger and the second heat exchanger;
a heat exchange apparatus, said apparatus being operatively associated with at least the second heat transfer fluid;
a distribution network for distributing the main fluid to a plurality of users.

2. The district heating plant according to claim 1, wherein the first refrigerant fluid is R513A and the second refrigerant fluid is R1233zd.

3. The district heating plant according to claim 1, wherein the second refrigerant fluid is brought into the third heat exchanger at temperatures comprised between 80 °C and 125 °C.

4. The district heating according to claim 1, comprising an economizer arranged on the first circuit, said economizer being arranged so that the first refrigerant fluid, between the second heat exchanger and the first heat exchanger, passes through a first inlet and a first outlet of the economizer, and the first circuit comprises a branch starting between the first outlet of the economizer and the first heat exchanger, and configured to send the first refrigerant fluid to a second inlet and a second outlet of the economizer, then to the first compressor.

5. The district heating plant according to claim 4, comprising a liquid receiver device arranged on the first circuit between the first outlet of the economizer and the start of the branch.

6. The district heating plant according to claims1, wherein the apparatus is a steam generator, said district heating plant comprising one or more steam recompression units along the distribution network.

7. The district heating plant according to claim 6, wherein the recompression unit comprises one or more Roots-type blowers or Venturi turbochargers or semi-hermetic or open compressors with coupling and bell cover.

8. The district heating plant according to claim 7, comprising a liquid receiver upstream of the recompression unit.

9. The district heating plant according to claim 6, wherein said apparatus is also operatively associated with the first heat transfer fluid.

10. The district heating plant according to claim 9, wherein said plant is configured for the first heat transfer fluid to thermoregulate a reaction triggered by the heat exchange between a main fluid and the second heat transfer fluid.

11. The district heating plant according to claim 1, to 10, comprising at least one unit consuming cold energy, and the plant comprises means for transferring cold energy from the first heat transfer fluid to said at least one unit.

12. A district heating method, comprising the steps of:
heating a main fluid;
said step of heating a main fluid comprising the steps of:
circulating a first refrigerant fluid in a first circuit;
during the step of circulating a first refrigerant fluid, exchanging heat between the first refrigerant fluid and a first heat transfer fluid so that the first heat transfer fluid transfers heat to the first refrigerant fluid, which evaporates;
circulating a second refrigerant fluid in a second circuit;
during the step of circulating a second refrigerant fluid, exchanging heat between the second refrigerant fluid and a second heat transfer fluid so that the second heat transfer fluid receives heat from the second refrigerant fluid;
exchanging heat between the first refrigerant fluid and the second refrigerant fluid so that the first refrigerant fluid transfers heat to the second refrigerant fluid and condenses, said step taking place for the second refrigerant fluid subsequent to the step of exchanging heat between the second refrigerant fluid and a second heat transfer fluid;
exchanging heat between the second heat transfer fluid and the main fluid, said step taking place after the second heat transfer fluid has received heat from the second refrigerant fluid;
circulating the heated main fluid within a distribution network for the distribution thereof to a plurality of users.

13. The method according to claim 12, wherein the step of exchanging heat between the second refrigerant fluid and a second heat transfer fluid takes place with the second refrigerant fluid at temperatures comprised between 80 °C and 125 °C.

14. A method for using a plant according to claim 1, wherein the second heat transfer fluid is used to heat a substance through said heat exchange apparatus, and the first heat transfer fluid is used to thermoregulate said heating.
